(19) United States
(12) Patent Application Publication
(10) Pub. No.: US 2023/0099005 A1
(43) Pub. Date: Mar. 30, 2023

(54) CONTROL METHOD FOR DISPLAY APPARATUS, CONTROL METHOD FOR SERVER, AND DISPLAY APPARATUS

(71) Applicant: SEIKO EPSON CORPORATION, Tokyo (JP)

(72) Inventor: Mitsunori TOMONO, Nagano-ken (JP)

(21) Appl. No.: 17/951,319

(22) Filed: Sep. 23, 2022

(30) Foreign Application Priority Data
Sep. 24, 2021 (JP) 2021-155800

(51) Int. Cl. H04L 9/40; H04L 12/18

(52) U.S. Cl. CPC H04L 63/083; H04L 12/1822

(57) ABSTRACT

A control method for a display apparatus includes transmitting login information for logging in a service provided by a server to the server by the display apparatus, receiving first information containing identification information of at least one other display apparatus registered in the server from the server, receiving an operation to select a first display apparatus of the at least one other display apparatus, and logging the first display apparatus in the service by transmitting second information containing the identification information of the first display apparatus acquired from the first information and the login information to the server.

The present application is based on, and claims priority from JP Application Serial Number 2021-155800, filed Sep. 24, 2021, the disclosure of which is hereby incorporated by reference herein in its entirety.

### BACKGROUND

### 1. Technical Field

The present disclosure relates to a control method for a display apparatus, a control method for a server, and a display apparatus.

### 2. Related Art

To receive a service provided by a server, it is necessary to be authenticated as a user and log in a server apparatus.

For example, International Publication No. 2015/063872 discloses a network viewing system conducting account authentication by entry of login information to a viewing device and receiving provision of contents provided by a content server after the account authentication.

However, when an apparatus receiving provision of a service is changed during the provision of the service provided by a server apparatus, it is necessary to perform a logout operation in the apparatus receiving the provision of the service, and then, perform a login operation in an apparatus to newly receive the service. Accordingly, a user is required to perform a plurality of operations and an improvement in usability is desired.

### SUMMARY

An aspect of the present disclosure is directed to a control method for a display apparatus including transmitting login information for logging in a service provided by a server to the server, receiving first information containing identification information of a plurality of other display apparatuses registered in the server from the server, receiving an operation to select a first display apparatus as one of the plurality of other display apparatuses, and logging the first display apparatus in the service by transmitting second information containing the identification information of the first display apparatus acquired from the first information and the login information to the server.

Another aspect of the present disclosure is directed to a control method for a server including receiving a change request to request a change of a display apparatus receiving provision of a service provided by the server from a display apparatus logging in the service, transmitting first information containing identification information of a plurality of other display apparatuses registered in the server to the display apparatus, receiving second information containing the identification information of a first display apparatus of one of the plurality of other display apparatuses and login information for logging in the service from the display apparatus, and transmitting a login request to the service containing the login information to the first display apparatus.

Another aspect of the present disclosure is directed to a display apparatus including a communication unit communicating with a server, and a control unit executing transmitting login information for logging in a service provided by the server to the server, receiving first information containing identification information of a plurality of other display apparatuses registered in the server from the server, receiving an operation to select a first display apparatus as one of the plurality of other display apparatuses, and logging the first display apparatus in the service by transmitting second information containing the identification information of the first display apparatus acquired from the first information and the login information to the server.

### BRIEF DESCRIPTION OF THE DRAWINGS

FIG. 1 shows an example of a system configuration.

FIG. 2 shows a configuration of a server.

FIG. 3 shows a configuration of a conference information management table.

FIG. 4 shows a configuration of a conference schedule management table.

FIG. 5 shows a configuration of a second server.

FIG. 6 shows an example of a configuration of a projector.

FIG. 7 shows an example of a configuration of an image projection section.

FIG. 8 shows an entry window.

FIG. 9 shows an example of a conference window.

FIG. 10 shows a conference window in which information representing statuses of use is displayed.

FIG. 11 is a flowchart showing operation of the projector.

FIG. 12 is a flowchart showing the operation of the projector.

FIG. 13 is a flowchart showing operation of the second server.

FIG. 14 is a flowchart showing the operation of the projector.

### DESCRIPTION OF EXEMPLARY EMBODIMENTS

1. System Configuration

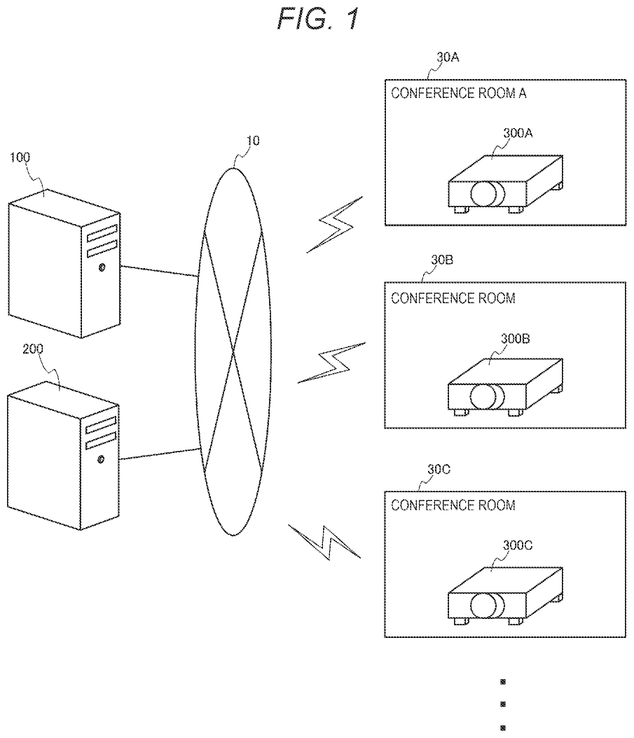

FIG. 1 shows an example of a system configuration.

An embodiment shown in FIG. 1 is a system including a first server 100, a second server 200, and a plurality of projectors 300 and coupling these apparatuses via a network 10. The network 10 may be e.g. a LAN (Local Area Network), a WAN (Wide Area Network) including a plurality of LANS, or the like. For a part of the network 10, a public communication network such as the Internet can be used.

The first server 100 is a server providing services to the projectors 300 and personal computers. Hereinafter, the projectors 300 and the personal computers receiving services provided by the first server 100 are collectively referred to as “client apparatuses”. The illustration of the personal computers as the client apparatuses is omitted.

The services provided by the first server 100 include e.g. Web conferences, delivery of contents such as moving pictures, and storage and sharing of files. In the embodiment, a case where the first server 100 provides a Web conference service is explained. Hereinafter, the Web conference is also simply referred to as “conference”.

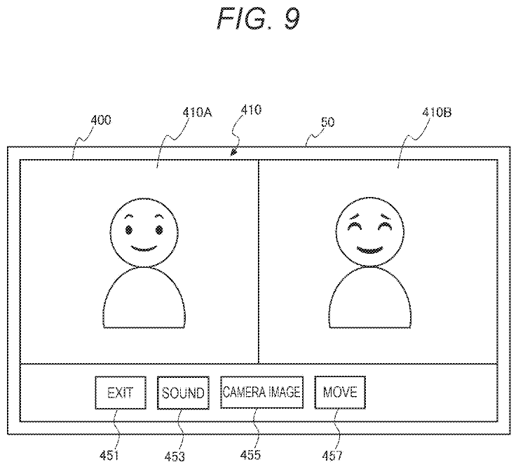

In the Web conference service, the first server 100 provides conference data to the client apparatuses logging in the same conference. The conference data contains captured images captured by the other client apparatuses, conference materials, sound data, etc. The client apparatus processes the conference data received from the first server 100 and displays a conference window 400 and outputs the sound data. The conference window 400 is a window in which a captured image by imaging of a user, the conference materials, etc. are displayed, and will be described later with reference to FIG. 9.

The second server 200 is a server performing control to activate the projectors 300 installed in conference rooms 30. For example, a case where, when the user is conducting a Web conference using a projector 300A in a conference room 30A, the user moves to the other conference room 30 for a reason that a scheduled time is expired or the like, is assumed. The user performs operation to move from the conference room 30A to the other conference room 30 using the projector 300A. In response to the operation, the second server 200 activates a projector 300B installed in a conference room 30B and controls the projector 300B to log in the Web conference service provided by the first server 100.

When receiving a request command to request a move of the conference room 30 from the projector 300, the second server 200 transmits first information to the projector 300 as the transmission source of the request command. The first information contains identification information of the projectors 300 registered in the second server 200 and information representing statuses of use of these projectors 300.

Hereinafter, the projector 300 transmitting the request command to the second server 200 is referred to as “pre-move projector 300”. The information representing statuses of use is information representing whether the projectors 300 are available or used for other conferences and unavailable.

The second server 200 receives second information from the pre-move projector 300 transmitted the first information. The second information contains a conference ID and a conference password of the conference logged in by the pre-move projector 300 and identification information of the projector 300 selected by the user using the pre-move projector 300. Hereinafter, the conference ID and the conference password are collectively referred to as “login information”.

When receiving the second information from the pre-move projector 300, the second server 200 transmits an activation request to the projector 300 represented by the identification information contained in the second information and activates the projector 300. The activated projector 300 is referred to as “post-move projector 300”. The projectors 300 not in use for a conference or the like are in network standby states. The network standby refers to a state in which power is supplied to the projector 300 via a power supply cord or an AC adapter and a communication function via the network 10 is enabled. When receiving the activation request or the like via the network 10, the projector 300 supplies power to a light source 331 etc. and returns to a normal state in which image display is enabled.

When transmitting the activation request to the projector 300 and activating the projector 300, the second server 200 transmits a login request containing the login information received from the pre-move projector 300 to the post-move projector 300. The login request is a login request to the conference logged in by the pre-move projector 300.

In FIG. 1, the case where the server includes the first server 100 and the second server 200 is explained, however, a single server may have functions of both the first server 100 and the second server 200.

The first server 100 and the second server 200 may be recognized as a single server by the projector 300 as the client apparatus accessing the first server 100 and the second server 200. The first server and the second server correspond to a server according to the present disclosure.

The plurality of projectors 300 are respectively installed in the conference rooms 30 where conferences are held. FIG. 1 shows the projector 300A installed in the conference room 30A, the projector 300B installed in the conference room 30B, and a projector 300C installed in a conference room 30C. FIG. 1 shows the three conference rooms 30, however, the number of conference rooms 30 is not limited to three, but may be two or more. In the embodiment, a case where the single projector 300 is installed in the single conference room 30 is explained, however, a plurality of projectors 300 may be installed in the single conference room 30. Hereinafter, the projectors 300A, 300B, and 300C are collectively referred to as “projectors 300”.

The projector 300 generates image light based on image data received from the personal computer coupled to the projector 300 or the first server 100, and projects the generated image light on a projection surface 50. Thereby, an image based on the image light is displayed on the projection surface 50. The image data received from the first server 100 is data contained in the conference data.

In the projector 300, an application program 363 for participation in the Web conference service provided by the first server 100 is installed. The user to participate in the conference starts the application program 363 and inputs login information by operating the projector 300. The projector 300 executing the application program 363 transmits the received login information to the second server 200 and authenticated by the second server 200.

2. Configuration of First Server 100

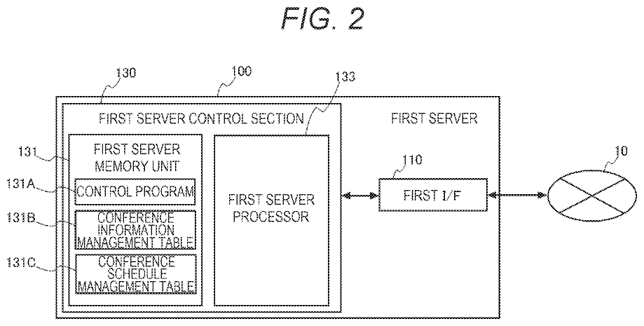

FIG. 2 is a block diagram showing a configuration of the first server 100. The configuration of the first server 100 is explained with reference to FIG. 2.

The first server 100 includes a first interface 110 and a first server control section 130. Hereinafter, the interface is also referred to as “I/F”.

The first I/F 110 is coupled to the network 10. The first I/F 110 transmits and receives data to and from the second server 200 and the projectors 300 through the network 10. The first I/F 110 may be a wired interface having a connecting terminal such as a USB (Universal Serial Bus) connector or an Ethernet connector and an interface circuit or a wireless communication interface. The Ethernet is a registered trademark.

The first server control section 130 is a computer apparatus including a first server memory unit 131 and a first server processor 133.

The first server memory unit 131 includes a volatile memory such as a RAM (Random Access Memory) and a non-volatile memory such as a ROM (Read Only Memory). The first server memory unit 131 includes an auxiliary storage device such as an SSD (Solid State Drive) or an HDD (Hard Disk Drive). The first server memory unit 131 stores a control program 131A executed by the first server processor 133, a conference information management table 131B, and a conference schedule management table 131C.

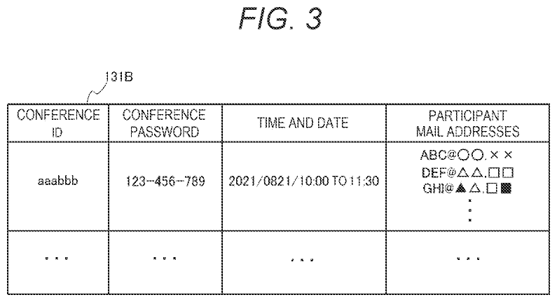

FIG. 3 shows a configuration of the conference information management table 131B.

In the conference information management table 131B, the conference password, a time and date of the conference, and mail addresses of participants of the conference are registered correspondingly to the conference ID.

The conference ID is identification information for identification of a conference and set for each conference. For example, the conference ID is generated by the first server 100 and the respective participants of the conference are notified by electronic mails.

The conference password is a password set by the host of the conference. The respective participants of the conference are notified of the conference password by electronic mails.

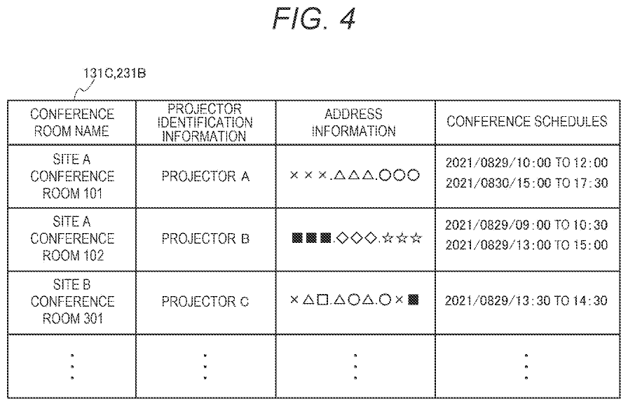

FIG. 4 shows a configuration of the conference schedule management table 131C.

The conference schedule management table 131C is a table for management of the conference schedule with respect to each conference room. In the conference schedule management table 131C, projector names, address information, and conference schedules are registered correspondingly to the conference room names for identification of the conference rooms 30. In addition, the conference ID and the conference password may be registered correspondingly to the conference room names.

The conference room name is a name of the conference room 30 and contains e.g. a name of a site in which the conference room 30 is placed and an identification number set for each conference room 30.

The projector identification information is information for identification of the projector 300 installed in the conference room 30 having the corresponding conference room name. The projector identification information may be a model name or a serial number of the projector 300 or a name of the projector 300 optionally set by the user.

The address information is an address such as an IP address or a MAC address of the projector 300 of the corresponding projector identification information. The conference schedule is schedule information of the conference set for the conference room 30 having the corresponding conference room name.

The first server processor 133 is an arithmetic processing unit including a CPU (Central Processing Unit) or an MPU (Micro Processing Unit). The first server processor 133 executes the control program 131A and controls the respective units of the first server 100.

Prior to the description of the operation of the first server processor 133, previous settings made by the host of the conference are explained.

First, for example, the host of the conference operates the personal computer in use by him- or herself and accesses the first server 100, and is authenticated as a user by the first server 100. When the user authentication by the first server 100 is successful, the host of the conference enters the conference information according to a window provided by the first server 100 and displayed on the display of the personal computer. The conference information contains the conference password, the time and date of the conference, the mail addresses of participants, the conference room names of the conference rooms 30 used for the conference, etc. The mail addresses include the mail address of the host of the conference.

A plurality of conference room names can be selected. In the Web conference, the client apparatuses installed in the different conference rooms 30 are coupled and the conference is conducted, and accordingly, a plurality of conference room names can be selected. The personal computer transmits the received conference information to the first server 100.

When receiving the conference information from the personal computer, the first server processor 133 first generates the conference ID. Then, the first server processor 133 extracts the conference password, the time and date of the conference, and the mail addresses of participants contained in the received conference information. The first server processor 133 registers the extracted conference password, time and date of the conference, and mail addresses of participants correspondingly to the generated conference ID in the same record in the conference information management table 131B.

Then, the first server processor 133 extracts the conference room names from the received conference information and registers the conference schedule in the record in the conference schedule management table 131C corresponding to the extracted conference room names. When registering the conference schedule in the conference schedule management table 131C, the first server processor 133 transmits the conference room names and the conference schedule to the second server 200.

Then, the first server processor 133 transmits information of the conference ID, the conference password, the time and date of the conference, the conference room names holding the conference, etc. to the mail addresses of the participants contained in the conference information.

Next, the operation of the first server processor 133 when receiving the login information from the projector 300 is explained.

When receiving the login information from the projector 300, the first server processor 133 determines whether or not the received login information coincides with the conference ID and the conference password registered in the conference information management table 131B.

When the login information does not coincide with the conference ID and the conference password registered in the conference information management table 131B, the first server processor 133 returns a response of failed authentication to the projector 300. When the login information coincides with the conference ID and the conference password registered in the conference information management table 131B, the first server processor 133 transmits a response of successful authentication to the projector 300. Then, the first server processor 133 transmits the conference data to the projector 300 and controls the projector 300 to display the conference window 400. 3. Configuration of Second Server 200

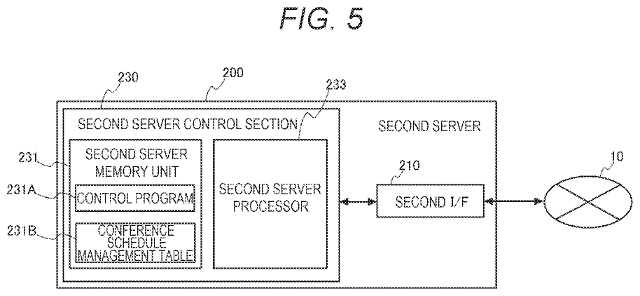

FIG. 5 is a block diagram showing a configuration of the second server 200. The configuration of the second server 200 is explained with reference to FIG. 5.

The second server 200 includes a second I/F 210 and a second server control section 230.

The second I/F 210 is coupled to the network 10. The second I/F 210 transmits and receives data to and from the first server 100 and the projectors 300 through the network 10. For example, the second I/F 210 may be a wired interface having a connecting terminal such as a USB connector or an Ethernet connector and an interface circuit or a wireless communication interface.

The second server control section 230 is a computer apparatus including a second server memory unit 231 and a second server processor 233.

The second server memory unit 231 includes a volatile memory such as a RAM and a non-volatile memory such as a ROM. The second server memory unit 231 includes an auxiliary storage device such as an SSD or an HDD. The second server memory unit 231 stores a control program 231A executed by the second server processor 233 and a conference schedule management table 231B.

The configuration of the conference schedule management table 231B is the same as the conference schedule management table 131C shown in FIG. 4 and the explanation of the details will be omitted.

The second server processor 233 is an arithmetic processing unit including a CPU or an MPU. The second server processor 233 executes the control program 231A and controls the respective units of the second server 200.

The second server processor 233 receives a request command to request a change of the conference room 30 from the pre-move projector 300 logging in the first server 100. When receiving the request command, the second server processor 233 acquires the conference room names of the respective conference rooms 30 registered in the conference schedule management table 231B and the identification information and the conference schedule of the projectors 300. The second server processor 233 determines whether or not the respective projectors 300 are in use or available based on the acquired conference schedule.

The second server processor 233 transmits the acquired conference room names, identification information of the projectors 300, and information representing statuses of use of the respective determined projectors 300 to the pre-move projector 300 as first information. The second server processor 233 may transmit the conference schedule acquired from the conference schedule management table 231B without change to the pre-move projector 300 in place of the information representing statuses of use.

Then, the second server processor 233 receives the second information from the pre-move projector 300. The second information contains the conference ID and the conference password of the conference logged in by the pre-move projector 300 and the identification information of the projector 300 selected by the user using the pre-move projector 300.

When receiving the second information from the pre-move projector 300, the second server processor 233 transmits an activation request to the post-move projector 300 as the projector 300 corresponding to the identification information contained in the received second information. The post-move projector 300 in the network standby state receives the activation request and is activated, and changes to a normal mode.

Then, the second server processor 233 transmits a login request containing the conference ID and the conference password to the post-move projector 300. The conference ID and the conference password contained in the login request are the conference ID and the conference password of the conference logged in by the pre-move projector 300.

When receiving the login request, the post-move projector 300 accesses the first server 100 with the conference ID and the conference password contained in the received login request as the login information and logs in the first server 100.

The second server processor 233 may transmit a logout request of the pre-move projector 300 to the first server 100 before transmitting the login request to the post-move projector 300.

4. Configuration of Projector 300

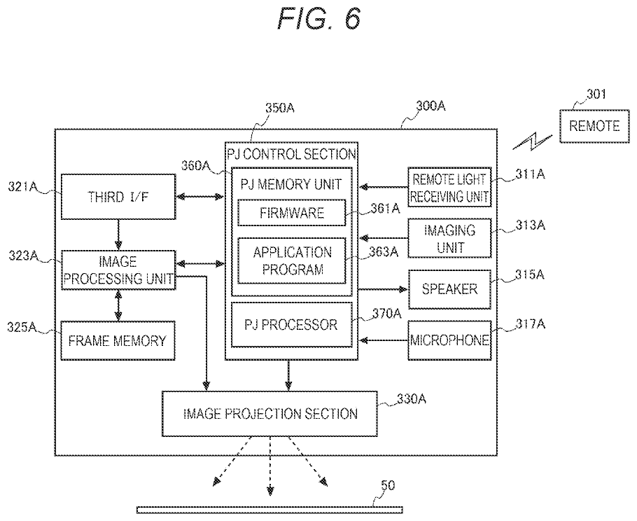

FIG. 6 is a block diagram showing an example of a configuration of the projector 300A.

The configuration of the projector 300A will be explained with reference to FIG. 6. The projectors 300B and 300C have the same configuration as the projector 300A. Accordingly, the explanation of the configurations of the projectors 300B and 300C will be omitted.

In the following description, components of the projector 300A have signs “A” and components of the projector 300B have signs “B”. For example, a PJ control section 350 of the projector 300A is referred to as “PJ control section 350A” and a PJ control section 350 of the projector 300B is referred to as “PJ control section 350B”.

The projector 300A includes a remote light receiving unit 311A, an imaging unit 313A, a speaker 315A, a microphone 317A, a third I/F 321A, an image processing unit 323A, a frame memory 325A, an image projection section 330A, and the PJ control section 350A.

The remote light receiving unit 311A receives an infrared signal transmitted by a remote 301. The remote light receiving unit 311A outputs an operation signal corresponding to the received infrared signal to the PJ control section 350A. The operation signal is a signal corresponding to the operated switch of the remote 301.

The imaging unit 313A includes an imaging lens, an imaging device such as a CCD (Charge Coupled Device) or a CMOS (Complementary MOS), and a data processing circuit. Illustration of an imaging optical system, the imaging device, and the data processing circuit is omitted. The imaging unit 313A images the room interior of the conference room 30A at preset intervals. The imaging unit 313A outputs a captured image generated by imaging to the PJ control section 350A. The participant in the conference is imaged in the captured image.

The speaker 315A outputs sound data input from the PJ control section 350A.

The microphone 317A inputs sound of the speech of the participant in the conference as sound data and outputs the input sound data to the PJ control section 350A.

The third I/F 321A is a wired interface having a connecting terminal such as a USB connector or an Ethernet connector and an interface circuit. The third I/F 321A may be a wireless communication interface. The third I/F 321A corresponds to a communication circuit.

The frame memory 325A is coupled to the image processing unit 323A. The frame memory 325A includes a plurality of banks. Each bank has memory capacity in which image data for one frame can be written. The frame memory 325A includes e.g. an SDRAM (Synchronous Dynamic Random Access Memory). The image processing unit 323A loads the image data input from the third I/F 321A in the frame memory 325A.

The image processing unit 323A performs image processing on the image data loaded in the frame memory 325A. The image processing performed by the image processing unit 323A includes e.g. resolution conversion processing or resize processing, distortion correction, shape correction processing, digital zoom processing, and adjustment of tint and brightness of the image. The image processing unit 323A executes the processing designated by the PJ control section 350A, and performs processing using a parameter input from the PJ control section 350A as necessary. Obviously, the image processing unit 323A can execute a combination of a plurality of kinds of the above described image processing. The image processing unit 323A reads out the image data loaded in the bank selected by the PJ control section 350A from the frame memory 325A and outputs the read out image data to the image projection section 330A.

The image processing unit 323A and the frame memory 325A are formed using e.g. an integrated circuit. The integrated circuit includes an LSI, an ASIC (Application Specific Integrated Circuit), a PLD (Programmable Logic Device), an FPGA (Field-Programmable Gate Array), and an SoC (System-on-a-chip). A part of the configuration of the integrated circuit may include an analog circuit or the PJ control section 350A and the integrated circuit may be combined.

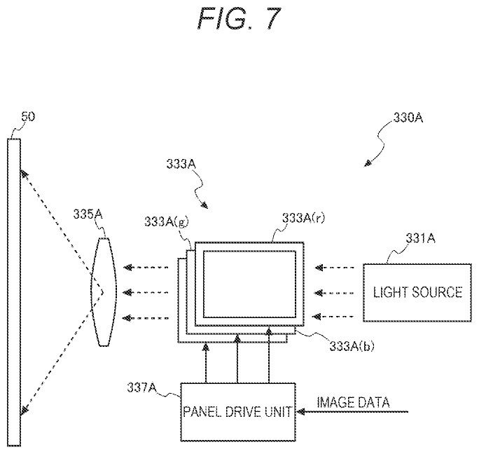

FIG. 7 shows an example of a configuration of the image projection section 330A.

Here, the configuration of the image projection section 330A is explained with reference to FIG. 7.

The image projection section 330A modulates light output from the light source 331A and generates image light and enlarges and projects the generated image light by an optical unit 335A. The image projection section 330A includes the light source 331A, three liquid crystal panels 333A (r), 333A (g), and 333A (b), the optical unit 335A, and a panel drive unit 337A. Hereinafter, the liquid crystal panels 333A (r), 333A (g), and 333A (b) of the projector 300A are collectively referred to as “liquid crystal panels 333A”.

The light source 331A includes a discharge light source lamp such as a super high-pressure mercury lamp or a metal halide lamp or a solid-state light source such as a light emitting diode or a semiconductor laser. The light output from the light source 331A is entered into the liquid crystal panels 333A. Each of the liquid crystal panels 333A (r), 333A (g), and 333A (b) includes a transmissive liquid crystal panel formed by enclosure of liquid crystal between a pair of transparent substrates or the like. The liquid crystal panel 333A (r) modulates a red light, the liquid crystal panel 333A (g) modulates a green light, and the liquid crystal panel 333A (b) modulates a blue light. In each liquid crystal panel, a pixel area of a plurality of pixels arranged in a matrix form is formed and a drive voltage can be applied to the liquid crystal with respect to each pixel.

The image data output by the image processing unit 323A is input to the panel drive unit 337A. The panel drive unit 337A applies drive voltages according to the input image data to the respective pixels in the pixel area and sets the respective pixels at light transmissivity according to the image data. The light output from the light source 331A is transmitted through the pixel areas of the liquid crystal panels 333A (r), 333A (g), and 333A (b) and modulated with respect to each pixel, and image lights corresponding to the image data are formed with respect to each color light. The formed image lights of the respective colors are combined with respect to each pixel by a light combining system (not shown) into an image light representing a color image. The optical unit 335A includes a projection lens etc. and enlarges and projects the image lights modulated by the liquid crystal panels 333A (r), 333A (g), and 333A (b) on the projection surface 50.

Returning to FIG. 6, the configuration of the PJ control section 350A is explained.

The PJ control section 350A is a computer apparatus including a PJ memory unit 360A and a PJ processor 370A.

The PJ memory unit 360A includes a volatile memory such as a RAM and a non-volatile memory such as a ROM or a flash memory. The PJ memory unit 360A stores firmware 361A and an application program 363A executed by the PJ processor 370A. Hereinafter, the application program 363A is referred to as “app 363A”.

The PJ processor 370A is an arithmetic processing unit including a CPU or an MPU. The PJ processor 370A executes the firmware 361A and controls the respective units of the projector 300A. The PJ processor 370A can be formed using a single processor or a plurality of processors. The PJ processor 370A may include part or all of the PJ memory unit 360A or an SoC integrated with another circuit. The PJ processor 370A may include a combination of a CPU executing a program and a DSP (Digital Signal Processor) executing predetermined arithmetic processing. Further, all of the functions of the PJ processor 370A may be mounted on hardware or configured using a programmable device.

The PJ control section 350A controls the image processing unit 323A and the image projection section 330A according to an instruction received from the first server 100 and displays an image on the projection surface 50.

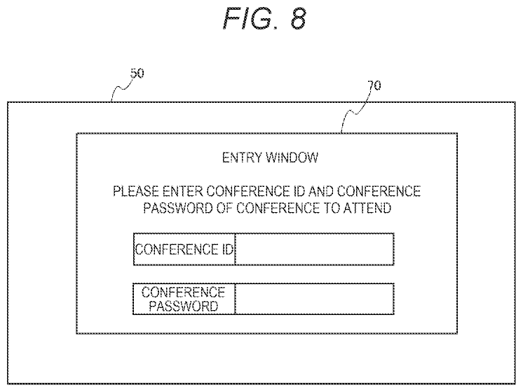

For example, when the remote 301 is operated and the application program 363A is selected, the PJ control section 350A executes the selected application program 363A. The PJ control section 350A executing the application program 363A displays an entry window 70 for requesting entry of the conference ID and the conference password. FIG. 8 shows the entry window 70 displayed on the projection surface 50 by the projector 300A.

When receiving the entry of the conference ID and the conference password, the PJ control section 350A transmits the received conference ID and conference password to the first server 100 as login information. When the conference ID and the conference password are authenticated by the first server 100, the PJ control section 350A displays the conference window 400 on the projection surface 50 based on the conference data transmitted from the first server 100. The conference window 400 contains captured images of the participants participating in the conference in the other sites in addition to the captured image by imaging of the conference room 30A with the projector 300A installed therein.

The PJ control section 350A transmits the captured image captured by the imaging unit 313A and sound data input by the microphone 317A to the first server 100.

Further, the PJ control section 350A receives the sound data of the participants participating in the conference in the other sites from the first server 100 and converts the received sound data into analog sound and outputs the sound from the speaker 315A.

FIG. 9 shows an example of the conference window 400.

The conference window 400 displays a plurality of child windows 410. FIG. 9 shows a state in which a child window 410A and two child windows 410 of a child window 410B are displayed. The number of child windows 410 displayed in the conference window 400 corresponds to the number of client apparatuses logging in the conference of the same conference ID. In the respective child windows 410A, 410B, the captured images captured by the client apparatuses and the conference materials are displayed.

In the lower part of the conference window 400, respective buttons including an exit button 451, a sound button 453, a camera image button 455, and a move button 457 are displayed.

The exit button 451 is for exiting, i.e., logging out from the conference in participation. When the exit button 451 is pressed down, the PJ control section 350A transmits a logout request to the first server 100.

The sound button 453 is a button for switching between output and non-output of the sound data input by the microphone 317A. The sound button 453 is pressed down and set to output, and thereby, the sound data input by the microphone 317A is output to the first server 100 and the other participants in the conference may hear the sound. The sound button 453 is pressed down again and set to non-output, and thereby, a mute state in which the sound data input by the microphone 317A is not output to the first server 100 is set.

The camera image button 455 is a button for switching between display and non-display of the captured image captured by the imaging unit 313A. The camera image button 455 is pressed down and set to display, and thereby, the captured image captured by the imaging unit 313A is transmitted to the first server 100 and displayed in the conference window 400. The camera image button 455 is pressed down again and set to non-display, and thereby, the captured image captured by the imaging unit 313A is not transmitted to the first server 100.

The move button 457 is a button for requesting a move of the conference room 30. When the move button 457 is pressed down, the PJ control section 350A transmits a request command to request the move of the conference room 30 to the second server 200.

When receiving the request command from the projector 300A, the second server 200 determines whether the respective projectors 300 are in use or available with reference to the conference schedule management table 231B and generates information representing the statuses of use. Then, the second server 200 transmits the conference room names and the identification information of the projectors 300 acquired from the conference schedule management table 231B and the generated information representing the statuses of use to the projector 300A as the first information.

Before transmission of the request command to the second server 200, the PJ control section 350A may let the user to enter information of the time of use for using the post-move conference room 30 and transmit the information of the entered time of use to the second server 200. For example, when the period of time input by the user is from 15:30 to 16:00, the section transmits the information to the second server 200. The second server 200 detects the projectors 300 not scheduled for any conference in the time of use based on the information of the time of use received from the projector 300A, and transmits the identification information of the detected projector 300A to the projector 300A.

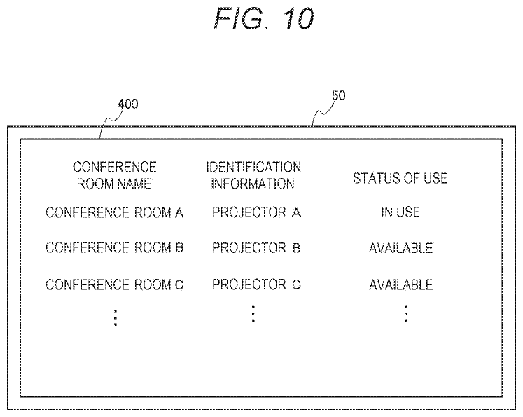

FIG. 10 shows the conference window 400 in which information representing statuses of use is displayed.

When receiving the first information from the second server 200, the PJ control section 350A displays the information representing the statuses of use of the projectors 300 based on the received first information on the projection surface 50.

When one of the projectors 300 for which the statuses of use are displayed is selected by the operation of the remote 301, the PJ control section 350A transmits the second information containing the identification information of the selected projector 300 to the second server 200. The second information contains the conference ID and the conference password of the conference logged in by the projector 300A and the identification information of the projector 300 selected by the user of the projector 300A.

5. Operations of Projector 300 and Second Server 200

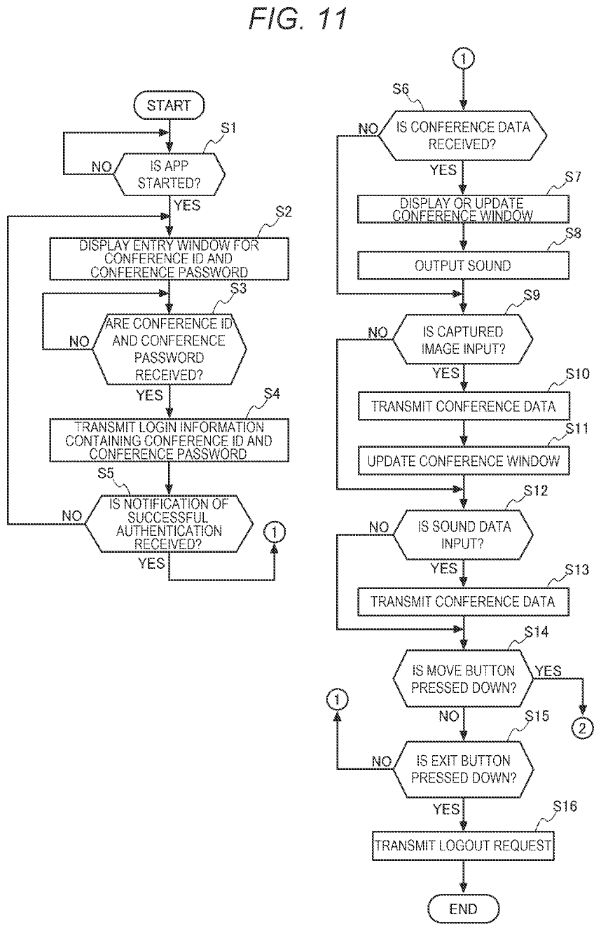

FIG. 11 is a flowchart showing operation of the projector 300A. The operation of the projector 300A will be explained with reference to the flowchart shown in FIG. 11. The operations of the projector 300B and the projector 300C are the same as that of the projector 300A and the detailed description will be omitted.

The PJ control section 350A determines whether or not the operation to start the app 363A is received by the remote 301 (step S1). When the operation to start the app is not received (step S1/NO), the PJ control section 350A waits until the operation to start the app is received.

When the operation to start the app is received by the remote 301 (step S1/YES), the PJ control section 350A displays the entry window 70 for the conference ID and the conference password (step S2). The user enters the conference ID and the conference password described in the mail received from the first server 100 in the entry window 70 using the remote 301.

The PJ control section 350A determines whether or not the entry of the conference ID and the conference password is received (step S3). When the entry of the conference ID and the conference password is not received (step S3/NO), the PJ control section 350A waits until the entry of the conference ID and the conference password is received.

When the entry of the conference ID and the conference password is received (step S3/YES), the PJ control section 350A transmits the login information containing the received conference ID and conference password to the first server 100 (step S4).

Then, the PJ control section 350A determines whether or not a notification of successful authentication is received from the first server 100 (step S5). When a notification of failed authentication is received from the first server 100 (step S5/NO), the PJ control section 350A returns to step S2 and displays the entry window 70 again, and receives the entry of the conference ID and the conference password.

When the notification of successful authentication is received from the first server 100 (step S5/YES), the PJ control section 350A determines whether or not the conference data is received from the first server 100 (step S6).

When the conference data is not received (step S6/NO), the PJ control section 350A goes to a determination at step S9. When the conference data is received (step S6/YES), the PJ control section 350A displays or updates the conference window 400 based on the image data contained in the received conference data (step S7) and, when the conference data contains sound data, outputs sound based on the sound data to the speaker 315A (step S8).

Then, the PJ control section 350A determines whether or not the captured image captured by the imaging unit 313A is input (step S9). When the captured image is input (step S9/YES), the PJ control section 350A generates conference data containing the input captured image and transmits the generated conference data to the first server 100 (step S10). The PJ control section 350A updates the conference window 400 using the input captured image (step S11). When the captured image is not input (step S9/NO), the PJ control section 350A goes to a determination at step S12.

Then, the PJ control section 350A determines whether or not sound data is input from the microphone 317A (step S12). When the sound data is input (step S12/YES), the PJ control section 350A generates conference data containing the input sound data and transmits the generated conference data to the first server 100 (step S13). When the sound data is not input (step S12/NO), the PJ control section 350A goes to a determination at step S14.

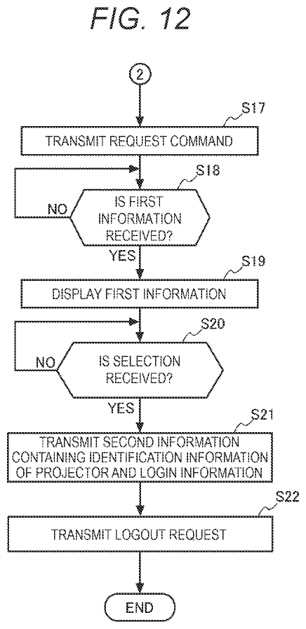

Then, the PJ control section 350A determines whether or not the move button 457 is pressed down (step S14). The operation of the PJ control section 350A when the move button 457 is pressed down will be explained with reference to a flowchart in FIG. 12.

When the move button 457 is not pressed down (step S14/NO), the PJ control section 350A determines whether or not the exit button 451 is pressed down (step S15). When the exit button 451 is not pressed down (step S15/NO), the PJ control section 350A returns to the determination at step S6. When the exit button 451 is pressed down (step S15/YES), the PJ control section 350A transmits a logout request to the first server 100 (step S16) and ends the processing flow.

FIG. 12 is a flowchart showing the operation of the projector 300A when the move button 457 is pressed down. The operation of the projector 300 when the move button 457 is pressed down will be explained with reference to the flowchart shown in FIG. 12.

When the move button 457 is pressed down (step S14/YES), the PJ control section 350A transmits a request command to request a move of the conference room 30 to the second server 200 (step S17). The request command to request a move corresponds to a change request.

Then, the PJ control section 350A determines whether or not the first information is received from the second server 200 (step S18). The first information contains the conference room names, the identification information of the projectors 300 installed in the conference rooms of the conference room names, and information representing the statuses of use of the projectors 300 corresponding to the identification information. When the first information is not received from the second server 200 (step S18/NO), the PJ control section 350A waits until the first information is received.

When the first information is received from the second server 200 (step S18/YES), the PJ control section 350A displays the received first information on the projection surface 50 (step S19). Then, the PJ control section 350A determines whether or not the operation to select one of the projectors 300 having the identification information contained in the first information is received (step S20). When the operation to select the projector 300 is not received (step S20/NO), the PJ control section 350A waits until the operation to select the projector 300 is received.

When the operation to select the projector 300 is received (step S20/YES), the PJ control section 350A transmits the second information containing the identification information of the selected projector 300 and the login information to the second server 200 (step S21). The login information is the conference ID and the conference password of the conference logged in by the projector 300A.

Then, the PJ control section 350A transmits a logout request to request logout from the logged in conference to the first server 100 (step S22).

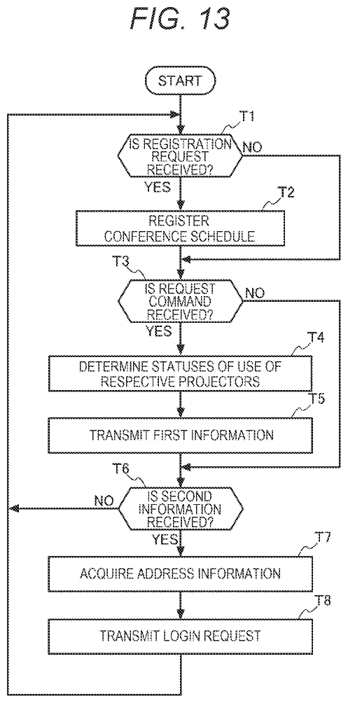

FIG. 13 is a flowchart showing operation of the second server 200. The operation of the second server 200 will be explained with reference to the flowchart shown in FIG. 13.

First, the second server control section 230 determines whether or not a registration request of the conference schedule is received from the first server 100 (step T1). When the registration request of the conference schedule is not received (step T1/NO), the second server control section 230 goes to a determination at step T3.

When the registration request of the conference schedule is received (step T1/YES), the second server control section 230 registers the conference schedule received from the first server 100 in the corresponding record of the conference schedule management table 231B (step T2).

Then, the second server control section 230 determines whether or not a request command to request a move of the conference room 30 is received from the projector 300 (step T3). When the request command is not received (step T3/NO), the second server control section 230 goes to a determination at step T6.

When the request command is received from the projector 300 (step T3/YES), the second server control section 230 acquires the conference room names, the identification information of the projectors 300, and the conference schedule with reference to the conference schedule management table 231B. The second server control section 230 determines whether or not the respective projectors 300 are in use or available based on the acquired conference schedule and generates information representing the statuses of use (step T4).

Then, the second server processor 233 transmits the conference room names and the identification information of the projectors 300 acquired from the conference schedule management table 231B and the generated information representing the statuses of use to the projector 300A as the first information (step T5). The projector 300A is the projector 300A as the transmission source transmitting the request command to the second server 200. The identification information of the projector 300 acquired from the conference schedule management table 231B corresponds to identification information of the display apparatus.

Then, the second server control section 230 determines whether or not the second information is received from the projector 300A (step T6). The second information contains the identification information of the projector 300 selected by the user using the projector 300A and the login information. When the second information is not received (step T6/NO), the second server control section 230 returns to the determination at step T1. The projector 300 represented by the identification information of the projector 300 contained in the second information corresponds to a first display apparatus.

When the second information is received (step T6/YES), the second server control section 230 acquires address information of the projector 300 corresponding to the identification information contained in the second information from the conference schedule management table 231B (step T7).

Then, the second server control section 230 transmits a login request containing the login information to the projector 300 of the acquired address information (step T8). The login information is the conference ID and the conference password contained in the second information received from the projector 300A.

Note that, in the flowcharts shown in FIGS. 11 and 12, the case where the projector 300A transmits the logout request to the first server 100 is explained. As another example, the second server 200 may transmit the logout request to the first server 100 and logs out the projector 300A from the conference logged in by the projector 300A.

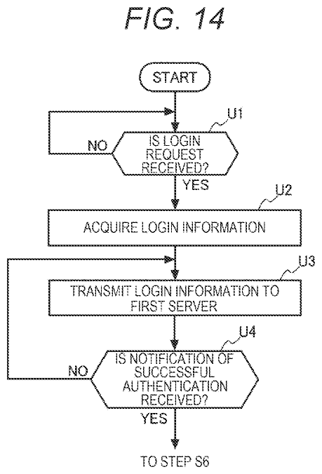

FIG. 14 is a flowchart showing the operation of the post-move projector 300.

The operation of the projector 300 will be explained with reference to the flowchart shown in FIG. 14. Here, the explanation is made on an assumption that the conference room 30 used for the conference is changed from the conference room 30A to the conference room 30B.

The PJ control section 350B determines whether or not a login request to request a login to the first server 100 is received from the second server 200 (step U1). When the login request is not received (step U1/NO), the PJ control section 350B returns to the determination at step U1.

When the login request is received from the second server 200 (step U1/YES), the PJ control section 350B acquires login information contained in the received login request (step U2). Then, the PJ control section 350B transmits the acquired login information to the first server 100 (step U3). Then, the PJ control section 350B determines whether or not a notification of successful authentication is received from the first server 100 (step U4). When a notification of failed authentication is received (step U4/NO), the PJ control section 350B returns to the processing at step U3. When the notification of successful authentication is received (step U4/YES), the PJ control section 350B goes to step S6 in the flowchart shown in FIG. 11.

6. Effects

As described above, the PJ control section 350A of the projector 300A of the embodiment executes the following processing.

The PJ control section 350A transmits the login information for logging in the service provided by the first server 100 to the first server 100.

Then, the PJ control section 350A receives the first information containing the identification information of the plurality of projectors 300B, 300C registered in the second server 200 from the second server 200.

Then, the PJ control section 350A receives the operation to select one of the plurality of projectors 300B, 300C. Here, for example, the selection of the projector 300B is assumed.

The PJ control section 350A transmits the second information containing the identification information of the projector 300B acquired from the first information and the login information to the second server 200, and thereby, the projector 300B is logged in the service logged in by the projector 300A.

Therefore, when the projector 300 receiving provision of the service is changed, the projector 300B to newly receive the provision of the service is selected, and thereby, the selected projector 300B logs in the service provided by the first server 100.

Accordingly, in the projector 300B after the change, time and effort to log in the service provided by the first server 100 may be saved and usability may be improved.

The PJ control section 350A transmits the identification information of the projector 300B and the login information to the second server 200, and then, transmits the logout request to log out the projector 300A from the service to the first server 100.

Therefore, time and effort to operate to logout by the user may be reduced.

The PJ control section 350A displays the entry window 70 for receiving entry of the login information and transmits the login information entered in the entry window 70 to the first server 100.

Therefore, the entry window 70 for the login information is displayed and entry of the login information is easier.

The second server control section 230 of the second server 200 executes the following processing.

The second server control section 230 receives the change request to request the change of the projector 300 receiving the provision of the service from the projector 300A logging in the service provided by the first server 100.

Then, the second server control section 230 transmits the first information containing the identification information of the plurality of projectors 300B, 300C registered in the second server 200 to the projector 300A.

Then, the second server control section 230 receives the second information containing the identification information of the projector 300B as one of the plurality of projectors 300B, 300C and the login information for logging in the service from the projector 300A.

Then, the second server control section 230 transmits the login request containing the login information to the service to the projector 300B represented by the identification information contained in the second information.

Therefore, when the projector 300 receiving the provision of the service is changed, the projector 300B to newly receive the provision of the service may be logged in the service provided by the first server 100.

Accordingly, time and effort to log the projector 300B to newly receive the provision of the service in the service may be saved and the usability may be improved.

The second server control section 230 transmits the activation request to the projector 300B in the standby state and activates the projector 300B, and then, transmits the login request to the projector 300B.

Therefore, the projector 300B in the standby state may be activated and logged in the service provided by the first server 100.

The second server control section 230 logs out the projector 300A from the service logged in by the projector 300A before transmitting the login request.

Therefore, the state in which the same user uses the different projectors 300 logging in the same service may be avoided.

The first information transmitted by the second server control section 230 to the projector 300A contains the information representing the statuses of use of the plurality of projectors 300B, 300C.

Therefore, the selection of the projectors 300B, 300C in use may be avoided.

7. Other Embodiments

The above described respective embodiments are preferred embodiments of the present disclosure. Note that the present disclosure is not limited to the above described embodiments, but various modifications can be made without departing from the scope of the present disclosure.

For example, in the above described embodiments, the case where the service provided by the first server 100 is the Web conference service is explained, however, the service may be a Web service requiring login information including delivery of contents such as moving images, storage and sharing of files, or the like.

In this case, the second information transmitted from the pre-move projector 300 to the second server 200 contains the following information.

That is, the second information contains the login ID and the login password for logging in the Web service, a URL (Uniform Resource Locator) of the Web service, and the identification information of the post-move projector 300.

When receiving the second information from the pre-move projector 300, the second server 200 acquires the address information corresponding to the identification information of the post-move projector 300.

The second server 200 outputs the activation request to the projector 300 of the acquired address information and activates the projector 300. Then, the second server 200 transmits the login request containing the login ID and the login password for logging in the Web service and the URL of the Web service to the activated post-move projector 300.

In the above described embodiments, the case where the display apparatus is the projector 300 is explained, however, the display apparatus may be a personal computer or a tablet computer.

The respective functional units of the first server 100 shown in FIG. 2, the second server 200 shown in FIG. 5, and the projector 300 shown in FIG. 6 show the functional configurations, but the specific mounting forms are not particularly limited. That is, hardware individually corresponding the respective functional units is not necessarily mounted, but, obviously, a single processor can realize functions of a plurality of functional units by executing programs. In the above described embodiments, part of the function realized by software may be realized by hardware and part of the function realized by hardware may be realized by software.

The units of processing of the flowcharts shown in FIGS. 11, 12, and 14 are formed by division according to the details of main processing for easy understanding of the operation of the projector 300. The present disclosure is not limited by the way of division and the names of the units of processing shown in the flowcharts in FIGS. 11, 12, and 14. The processing in the projector 300 may be divided into more units of processing according to the details of processing or divided so that a single unit of processing may include more pieces of processing. The orders of processing in the above described flowcharts are not limited to the illustrated examples.

The units of processing of the flowchart shown in FIG. 13 are formed by division according to the details of main processing for easy understanding of the operation of the second server 200. The present disclosure is not limited by the way of division and the names of the units of processing shown in the flowchart in FIG. 13. The processing in the second server 200 may be divided into more units of processing according to the details of processing or divided so that a single unit of processing may include more pieces of processing. The order of processing in the above described flowchart is not limited to the illustrated example.

When the control method for the display apparatus, the display apparatus, and the management method for the login information are realized using the computer of the projector 300, the program executed by the computer can be configured in a form of a recording medium. The program executed by the computer can be configured in a form of a transmission medium transmitting the program. A magnetooptical recording medium or a semiconductor memory device may be used for the recording medium. Specifically, the recording medium includes a portable or fixed recording medium such as a flexible disc, an HDD, a CD-ROM (compact disc read-only memory), a DVD (Digital Versatile Disc), a Blu-ray Disc, a magnetooptical disc, a flash memory, and a card-type recording medium. The recording medium may be a non-volatile memory device including a RAM, a ROM, and an HDD as an internal memory device of a server apparatus. The Blu-ray is a registered trademark.

What is claimed is:

1. A control method for a display apparatus comprising:
transmitting login information for logging in a service provided by a server to the server by a display apparatus;
receiving, from the server, first information including identification information of at least one other display apparatus different from the display apparatus registered in the server;
receiving an operation to select a first display apparatus of the at least one other display apparatus; and
logging the first display apparatus in the service by transmitting second information including the identification information of the first display apparatus acquired from the first information and the login information to the server.

2. The control method for a display apparatus according to claim 1, further comprising transmitting a logout request to log out the display apparatus from the service to the server after transmitting the identification information of the first display apparatus and the login information to the server.

3. The control method for a display apparatus according to claim 1, further comprising displaying an entry window for receiving entry of the login information.

4. A control method for a server comprising:
receiving a change request to request a change of a display apparatus receiving provision of a service provided by a server from a display apparatus logging in the service;
transmitting first information including identification information of at least one other display apparatus registered in the server to the display apparatus;
receiving second information including the identification information of a first display apparatus of the at least one other display apparatus and login information for logging in the service from the display apparatus; and
transmitting a login request to the service including the login information to the first display apparatus.

5. The control method for a server according to claim 4, further comprising transmitting an activation request to request activation to the first display apparatus which is in a standby state, wherein
transmitting the login request includes transmitting the login request to the first display apparatus after the first display apparatus is activated according to the activation request.

6. The control method for a server according to claim 4, wherein
the display apparatus is logged out from the service before transmission of the login request.

7. The control method for a server according to claim 4, wherein
the first information includes information representing a status of use of the at least one other display apparatus.

8. A display apparatus comprising:
a communication circuit communicating with a server; and
at least one processor programmed to execute transmitting login information for logging in a service provided by a server to the server using the communication circuit,
receiving, from the server, first information including identification information of at least one other display apparatus registered in the server,
receiving an operation to select a first display apparatus of the at least one other display apparatus, and
logging the first display apparatus in the service by transmitting, using the communication circuit, second information including the identification information of the first display apparatus acquired from the first information and the login information to the server.
